(19) United States
(12) Patent Application Publication
(10) Pub. No.: US 2026/0161530 A1
(43) Pub. Date: Jun. 11, 2026

(54) CODE INFRACTION QUALITY VALIDATOR WITH LLM PROPOSED SOLUTIONS

(71) Applicant: ServiceNow, Inc., Santa Clara, CA (US)

(72) Inventor: Alexander Pierre Dyson-Coope, Aylesbury (GB)

(21) Appl. No.: 18/971,625

(22) Filed: Dec. 6, 2024

(51) Int. Cl. G06F 11/362; G06F 8/70; G06F 9/54

(52) U.S. Cl. CPC G06F 11/3624; G06F 8/70; G06F 9/54

(57) ABSTRACT

A method includes obtaining a portion of a code file that is associated with metadata and selecting a prompt template from a set of prompt templates. Each of the prompt templates includes a respective request and a respective metadata placeholder. The method includes populating the respective metadata placeholder of the prompt template with the metadata associated with the portion of the code file. The method includes generating a code modification based on the portion of the code file, the respective request of the prompt template, and the metadata of the populated prompt template. The method includes modifying the portion of the code file based on the code modification.

### TECHNICAL FIELD

This disclosure relates to proposed solutions for code infractions.

### BACKGROUND

Software code infractions commonly refer to violations of predefined rules or standards that govern the syntax, style, structure, and/or quality of software code. Code infractions can impair the readability, maintainability, security, performance, and functionality of software applications, and may lead to errors, bugs, and vulnerabilities. Various tools and methods exist to detect, report, or correct code infractions, such as code analyzers, code formatters, code linters, code refactoring tools, and code review processes. However, these tools have limitations, such as requiring manual intervention, being incompatible with different programming languages or environments, producing false positives or negatives, and being inefficient or inaccurate.

### SUMMARY

One implementation of the disclosure provides a computer-implemented method of using a code infraction validator to propose solutions. The method includes obtaining a portion of a code file that is associated with metadata and selecting a prompt template from a set of prompt templates. Each of the prompt templates includes a respective request and a respective metadata placeholder. The method includes populating the respective metadata placeholder of the prompt template with the metadata associated with the portion of the code file. The method includes generating, using a model, a code modification based on the portion of the code file, the respective request of the prompt template, and the metadata of the populated prompt template and modifying the portion of the code file based on the code modification.

Implementations of the disclosure may include one or more of the following optional features. In some implementations, the method further includes obtaining a portion of a second code file including a second code infraction and is associated with second metadata, selecting a second prompt template from the set of prompt templates, and populating the respective metadata placeholder of the second prompt template with the second metadata associated with the portion of the second code file. In these implementations, the method may further include generating, using the model, a second code modification based on the respective request of the second prompt template and the second metadata of the populated second prompt template, determining that the second code modification fails to satisfy a threshold, selecting, from the set of prompt templates, a third prompt template different from the second prompt template based on determining that the second code modification fails to satisfy the threshold, and populating the respective metadata placeholder of the third prompt template with the second metadata associated with the portion of the second code file.

Here, the method may further include generating, using the model, a third code modification based on the respective request and the second metadata of the populated third prompt template and modifying the portion of the second code file based on the third code modification. In some examples, the method further includes determining that the third code modification satisfies the threshold. Here, modifying the portion of the second code file is further based on determining that the third code modification satisfies the threshold. In some implementations, determining that the second code modification fails to satisfy the threshold includes determining that the second code modification fails to correct a code infraction and determining that the third code modification satisfies the threshold includes determining that the third code modification corrects the code infraction.

In some examples, the portion of the code file includes a code infraction and a plaintext message in a first language. The code infraction indicates that the plaintext message in the first language is not translatable to a second language different from the first language. In these examples, the code modification may include an application programming interface (API) call requesting translation of the plaintext message into one of a plurality of different languages and modifying the portion of the code file includes inserting the API call into the portion of the code file. Alternatively, the code modification may include an abstracted plaintext message translatable from the first language into the second language and modifying the portion of the code file includes replacing the plaintext message with the abstracted plaintext message.

The method may further include extracting the metadata associated with the portion of the code file where the metadata includes a result type of the portion of the code file. In some implementations, the method further includes obtaining a plurality of training samples each having a training code infraction paired with a ground-truth code modification and training the model on the plurality of training samples. In these implementations, training the model on the plurality of training samples includes updating parameters of the model. In some examples, the method further includes generating a user presentation including the code modification before modifying the portion of the code file and receiving an affirmative response to the user presentation. Here, modifying the portion of the code file is further based on receiving the affirmative response to the user presentation.

In some implementations, the portion of the code file includes a plurality of parameters, one of the plurality of parameters is associated with a code infraction, and modifying the portion of the code file includes applying the code modification to the one of the plurality of parameters. The model may correspond to a large language model (LLM). In some examples, selecting the prompt template is based on an order of the set of prompt templates. The method may further include generating a prompt based on the respective request of the prompt template and the metadata of the populated prompt template. Here, wherein generating the code modification is further based on the prompt. In some examples, determining that the portion of the code file includes plaintext in a first language that is not translatable to a second language and determining that the portion of the code file includes a code infraction based on determining that the portion of the code file includes plaintext in a first language that is not translatable to a second language.

Another implementation of the disclosure provides a system that includes data processing hardware and memory hardware storing instructions that when executed on the data processing hardware causes the data processing hardware to perform operations. The operations include obtaining a portion of a code file that is associated with metadata and selecting a prompt template from a set of prompt templates. Each of the prompt templates includes a respective request and a respective metadata placeholder. The operations include populating the respective metadata placeholder of the prompt template with the metadata associated with the portion of the code file. The operations include generating, using a model, a code modification based on the portion of the code file, the respective request of the prompt template, and the metadata of the populated prompt template and modifying the portion of the code file based on the code modification.

Another implementation of the disclosure provides a computer-readable medium having instructions that, when executed by data processing hardware, causes the data processing hardware to perform operations. The operations include obtaining a portion of a code file that is associated with metadata and selecting a prompt template from a set of prompt templates. Each of the prompt templates includes a respective request and a respective metadata placeholder. The operations include populating the respective metadata placeholder of the prompt template with the metadata associated with the portion of the code file. The operations include generating, using a model, a code modification based on the portion of the code file, the respective request of the prompt template, and the metadata of the populated prompt template and modifying the portion of the code file based on the code modification.

The details of one or more implementations of the disclosure are set forth in the accompanying drawings and the description below. Other implementations, features, and advantages will be apparent from the description and drawings, and from the claims.

### DESCRIPTION OF DRAWINGS

FIG. 1 is a schematic view of an example system executing a code validator.

FIG. 2 is a schematic view of an example code validator.

FIGS. 3A and 3B illustrate example prompt templates.

FIG. 4 is a flowchart of an example arrangement of operations for a computer-implemented method of using a code infraction validator to propose solutions.

FIG. 5 is a schematic view of an example computing device that may be used to implement the systems and methods described herein.

Like reference symbols in the various drawings indicate like elements.

### DETAILED DESCRIPTION

Software development is a complex and error-prone process that requires constant testing and debugging to ensure the quality and functionality of the code.

However, finding and fixing code errors can be time-consuming and computationally expensive, especially for large and complex software systems that involve multiple languages, frameworks, and dependencies. Moreover, some code errors may be subtle, ambiguous, or context-dependent, thereby requiring a high level of expertise and domain knowledge to diagnose and resolve.

Some approaches of correcting code errors rely on manual inspection or automated testing tools that can detect syntactic, semantic, or logical errors in the code. After identifying the code error, the code still needs to be corrected to address the code error. However, there is no guarantee that the proposed fix for the code error will in fact resolve the code error or be an optimized solution for the code error. Accordingly, there is a need for detecting and correcting code infractions in an efficient and reliable manner.

To that end, implementations herein are directed towards methods and systems of correcting code errors. The implementations may include obtaining or identifying a portion of a file that has a code infraction. The portion of the code is associated with metadata. The implementations may also include selecting a first prompt template from a set of prompt templates. Each prompt template includes a respective request and a respective metadata placeholder. The implementations optionally include populating the respective metadata placeholder of the first prompt template with the metadata associated with the portion of the code file and generating a first code modification based on the populated first prompt template using a model such as a large language model (LLM). The implementations also include determining that the first code modification fails to satisfy a threshold and selecting a second prompt template from the set of prompt templates based on determining that the first code modification fails to satisfy the threshold. The threshold may indicate an amount of improvement or any other metric or quality of the code modification. The implementations also include populating the respective metadata placeholder of the second prompt template with the metadata associated with the portion of the code file and generating a second code modification based on the populated second prompt template using the model. The operations also include modifying the portion of the code based on the second code modification.

As such, these implementations of correcting code errors may leverage the natural language processing abilities of models such as LLMs to correct code errors. Moreover, by determining whether each code modification satisfies the threshold before modifying the code portion, the model may sequentially progress through different prompt templates to generate optimal code modification. For example, initially selected prompt templates may include relatively specific requests to modify the code while subsequently selected prompt templates include relatively broader requests to modify the code. As such, the model first processes populated prompt templates with specific code modification requests and advances to processing populating prompt templates that are increasingly broader. Thus, if the model produces a code modification that satisfies the threshold based on processing a specific code modification request, the model does not need to proceed with processing a broader code modification request thereby reducing the amount of time and computational resources required to generate the code modification.

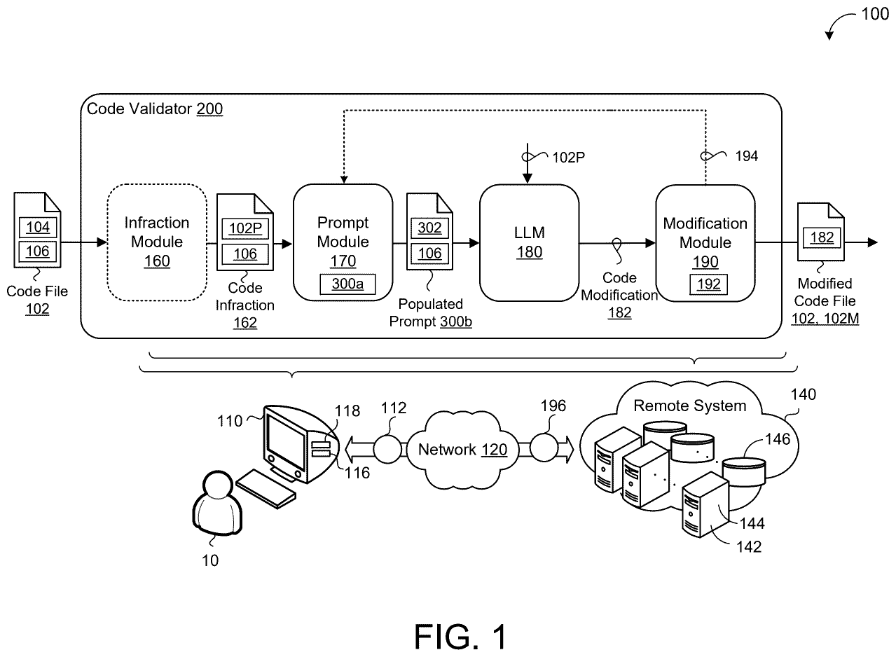

Referring to FIG. 1, in some implementations, a system 100 includes a remote system 140 in communication with one or more user device 110 each associated with a respective user 10 via a network 120, such as the Internet, a local area network (LAN), a wide area network (WAN), a cellular network, or a wireless network. The remote system 140 may be a single computer, multiple computers, or a distributed system (e.g., a cloud environment) having scalable/elastic resources 142 including computing resources 144 (e.g., data processing hardware) and/or storage resources 146 (e.g., memory hardware). The remote system 140 is configured to communicate with the user device 110 via the network 120. The user device 110 may correspond to any computing device, such as a desktop workstation, a laptop workstation, or a mobile device (i.e., a smart phone). Each user device 110 includes computing resources 116 (e.g., data processing hardware) and/or storage resources 118 (e.g., memory hardware).

The remote system 140 and/or the user device 110 may execute a code validator 200. For instance, some components of the code validator 200 may execute on the data processing hardware 116 of the user device 110 while other components of the screen reader 150 execute on the data processing hardware 144 of the remote system 140. The code validator 200 includes an infraction module 160, a prompt module 170, a model 180, and a modification module 190. The model 180 may correspond to a large language model (LLM), and thus, the model 180 may also be referred to as the LLM 180 herein.

The code validator 200 is configured to process a plurality of code files 102 to determine or identify whether the code files 102 include any code infractions. Each code file 102 may include code 104 and metadata 106. In some implementations, the code validator 200 excludes the infraction module 160 (e.g., denoted by the dotted line around the infraction module 160) and obtains the code infractions 162 from another component within the system 100. The code 104 refers to the actual set of instructions written in a programming language that is intended to be executed by the data processing hardware 116, 144. The code 104 can be written in various programming languages such as Python, Java, C++, or any other language suitable for the specific application or system. The purpose of the code 104 is to perform specific tasks or functions that may range from simple scripts to complex algorithms and software applications.

Metadata 106, on the other hand, includes details that describe the code 104, such as the author of the code, the date it was created, version information, dependencies, and other relevant attributes. Metadata 106 helps in organizing, managing, and understanding the code files 102 more effectively. The metadata 106 may also include comments within the code 104 that explain the purpose and functionality of different sections, making it easier for other developers to read and maintain the code 104. Moreover, the metadata 106 may indicate a result type for each function within the code file 102. That is, each portion of the code file 102 may be associated with respective metadata 106.

Based on identifying a code infraction 162 for a respective code file 102 the code validator 200 determines a corresponding code modification 182 for the code file 102 to rectify the identified code infraction 162. In some configurations, the code validator 200 automatically processes the plurality of code files 102 without requiring any input from the user 10. The automatic processing allows for continuous and efficient code validation, thereby minimizing the need for manual intervention by the user 10. In other configurations, the code validator 200 processes one or more of the code files 102 in response to receiving a request from the user 10. Here, the request may indicate one or more of the code files 102 for the code validator 200 to process.

Code infractions 162 may include any deviation or violation of predefined coding standards, guidelines, or best practices within a software development environment. Thus, code infractions 162 span a wide range of issues, from minor stylistic discrepancies, such as improper indentation or naming conventions, to more significant errors that may adversely affect the functionality, security, or performance of the software. The code validator 200 may employ a variety of techniques to identify code infractions 162 from the code files 102 including static analysis, pattern matching, and heuristic algorithms. The code validator 200 uses static analysis to examine code files 102 without executing the code files 102, identifying syntax errors, type mismatches, and other potential issues. The code validator 200 uses pattern matching to search for specific patterns in the code files 102 that are known to be problematic, such as hardcoded passwords or deprecated functions.

The infraction module 160 receives the code files 102 and determines whether or not each code file 102 includes a corresponding code infraction 162. In some examples, the infraction module 160 automatically receives or obtains a particular code file 102 for processing without receiving a particular request from the user 10. In other examples, the infraction module 160 obtains the particular code file 102 based on a receiving request specifying the particular code file 102 from the user 10. Based on determining that a respective code file 102 includes a corresponding code infraction 162, the infraction module 160 outputs the identified code infraction 162 to the prompt module 170. The code infraction 162 may include a portion of the code file 102, 102P associated with the code infraction 162 (e.g., the code 104 from the code file 102 that causes the code infraction 162) and metadata 106 associated with the portion of the code file 102. That is, the code infraction 162 may only include the portion of the code file 102 that caused the infraction and exclude other portions from the code file 102. The metadata 106 associated with the portion of the code file 102P may indicate the expected result type or function type of the portion of the code file 102P. The result type may include at least one of an alert message, an error message, or a show field message. In some examples, the infraction module 160 or the prompt module 170 extracts the metadata 106 from the portion of the code file 102P.

For example, the infraction module 160 may identify the code infraction 162 from the portion of the code file 102P corresponding to “addErrorMessage(”Enter a valid date“).” In this example, the hardcoded text of “Enter a valid date” from the portion of the code file 102P causes the code infraction 162 because the hardcoded text includes a plaintext message in a first language (e.g., English) that is not translatable to a second language (e.g., Spanish) that is different from the first language. In particular, if the portion of the code file 102 from the example was executed for a Spanish speaking user, the resulting text would be produced in English and not Spanish because the plaintext message is hardcoded. Moreover, in this example, the code infraction 162 may include the metadata 106 associated with the portion of the code file 102P indicating that the portion of the code file 102P includes an error message result type.

The prompt module 170 selects a prompt template 300 from a set of prompt templates 300. The set of prompt templates 300 the prompt module 170 selects from may include unpopulated prompt templates 300, 300a. Each unpopulated prompt template 300a includes a respective request 302 and a respective metadata placeholder 304. The request 302 includes natural language text requesting the LLM 180 to perform a certain action. The metadata placeholder 304 includes a variable or a symbol that represents a metadata attribute or value that is to be filled by the prompt module 170. In some examples, the prompt module 170 is configured to select the prompt templates 300 in a predetermined order. That is, the set of prompt templates 300 may include an ordered set of prompt templates 300 such that the prompt module 170 selects a first prompt template 300 during a first iteration, a second prompt template 300 during a second iteration, a third prompt template during a third iteration, and so on, until the code validator 200 generates a suitable code modification 182.

The ordered set of prompt templates 300 may be arranged such that the prompt templates 300 with more specific or narrow requests 302 are selected earlier in the order and the prompt templates 300 with the more generic or broad requests 302 are selected later in the order. LLMs 180 tend to produce higher quality outputs with specific or narrow instructions. Yet, in some scenarios, when the instructions are too narrow, the LLM 180 produces a result that is not responsive to the instructions (i.e., does not correct the code infraction 162). Thus, by selecting prompt templates 300 with more narrow or specific requests 302 earlier in the order, the prompt module 170 ensures that the LLM 180 is given the opportunity to produce a high-quality code modification 182. Moreover, if the narrow or specific requests 302 are too narrow such that the generated code modifications 182 to not solve or correct the code infraction 162, the prompt module 170 iteratively selects prompt templates 300 with more generic or broad requests 302. The generic requests 302 still enable the LLM 180 to generate code modifications 182 that solve the code infraction 162, but the code modifications 182 may be more generic in nature. As will become apparent, the prompt module 170 may continue iteratively selecting and populating prompt templates 300 from the set of prompt templates 300 until the code validator 200 generates a suitable code modification 182.

After selecting the prompt template 300, the prompt module 170 populates the respective metadata placeholder 304 of the selected prompt template 300 with the metadata 106 associated with the portion of the code file 102P to produce a populated prompt template 300, 300b. Put another way, the prompt module 170 inserts the metadata 106 from the portion of the code file 102P into the respective metadata placeholder 304 of the selected prompt template 300. Thus, the populated prompt template 300b includes the respective request 302 and the metadata 106 in place of the respective metadata placeholder 304.

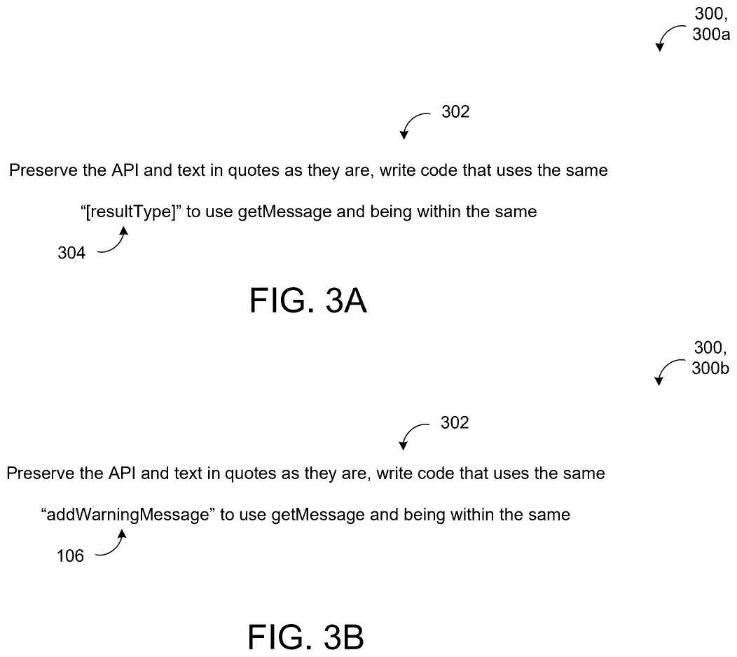

FIGS. 3A and 3B illustrate an example unpopulated prompt template 300a (FIG. 3A) and an example populated prompt template 300b (FIG. 3B). Here, the unpopulated prompt template 300a includes “Preserve the API and text in quotes as they are, write code that uses the same “[resultType]” to use getMessage and being within the same” whereby the “[resultType]” corresponds to the metadata placeholder 304 and all other text corresponds to the request 302. FIG. 3B shows the populated prompt template 300b which the prompt module 170 generates based on the unpopulated prompt template 300a (FIG. 3A) and the metadata 106. In the example shown, the prompt module 170 replaced the metadata placeholder 304 of “[resultType]” with the metadata 106 of “addWarningMessage.” As such, the populated prompt template 300b includes “Preserve the API and text in quotes as they are, write code that uses the same ”addWarningMessage“ to use getMessage and being within the same.” Advantageously, the populated prompt template 300b includes the result type of the portion of the code file 102P indicated by the code infraction 162 such that the LLM 180 has additional context when generating the code modification 182.

Referring again to FIG. 1, the LLM 180 processes the portion of the code file 102P from the code infraction 162 and the populated prompt template 300b to generate a code modification 182. That is, the LLM 180 generates the code modification 182 based on the portion of the code file 102P from the code infraction 162, the respective request 302 of the selected prompt template 300, and the metadata 106 of the populated prompt template 300b. A training process may obtain a plurality of training samples with each training sample including training code infraction paired with a ground-truth code modification and train the LLM 180 on the plurality of training samples. That is, the training process may compare predictions generated based on the training samples to the corresponding ground-truth code modification to determine a loss and train the LLM 180 based on the determined loss. Here, training the LLM 180 may include updating parameters of the LLM 180 based on the loss.

The code modification 182 is intended to correct the code infraction 162 identified by the infraction module 160. In some examples, the code modification 182 includes one or more changes to the syntax, structure, or content of the portion of the code file 102P. The modification module 190 may determine whether the code modification 182 resolves the code infraction 162. However, whether the code modification 182 corrected the code infraction 162 depends on the populated prompt template 300b generated by the prompt module 170. That is, the modification module 190 may determine whether the code modification 182 satisfies a threshold 192. Here, the threshold 192 may correspond to whether the code modification 182 corrects the code infraction 162.

Based on determining that the code modification 182 resolves the code infraction 162 (i.e., satisfies the threshold 192), the modification module 190 modifies the portion of the code file 102P based on the code modification 182 to produce a modified code file 102, 102M which includes the code modification 182. Thereafter, the system 100 may execute the modified code file 102M. Modifying the portion of the code file 102P may include replacing the code 104 of the portion of the code file 102P with the code modification 182. On the other hand, based on determining that the code modification 182 fails to resolve the code infraction 162 or introduces a new code infraction 162, the modification module 190 may generate a notification 194 and transmit the notification 194 to the prompt module 170.

The prompt module, based on receiving the notification 194 from the modification module 190 may select another prompt template 300 from the set of prompt templates 300 different from any of the previously selected prompt templates 300 for the portion of the code file 102P. As such, the prompt module 170 may iteratively select prompt templates 300 according to the order of prompt templates 300 each time the prompt module 170 receives the notification 194 from the modification module 190. That is, the notification 194 informs the prompt module 170 that the previously selected prompt template 300 included a request 302 that was too narrow such that the code modification 182 did not resolve the code infraction 162. Based on this information, the prompt module 170 may select another prompt template 300 from the set of prompt templates 300 according to the order.

Thereafter, prompt module 170 may populate the other prompt template 300 with the metadata 106 and the LLM 180 may process the other populated prompt template 300b to generate another code modification 182. The modification module 190 determines whether the other code modification 182 satisfies the threshold 192. When the other code modification 182 satisfies the threshold 192, the modification module 190 modifies the portion of the code file 102P with the other code modification 182. Otherwise, when the other code modification 182 fails to satisfy the threshold 192, the modification module 190 generates another notification 194 such that the prompt module 170 selects yet another prompt template 300. This iterative process may continue until the code validator 200 generates a code modification 182 that satisfies the threshold 192. Determining that the code modification 182 satisfies the threshold 192 may include determining that the code modification 182 corrects the code infraction 162. On the other hand, determining that the code modification 182 fails to satisfy the threshold 192 may include determining that the code modification 182 fails to correct the code infraction 162.

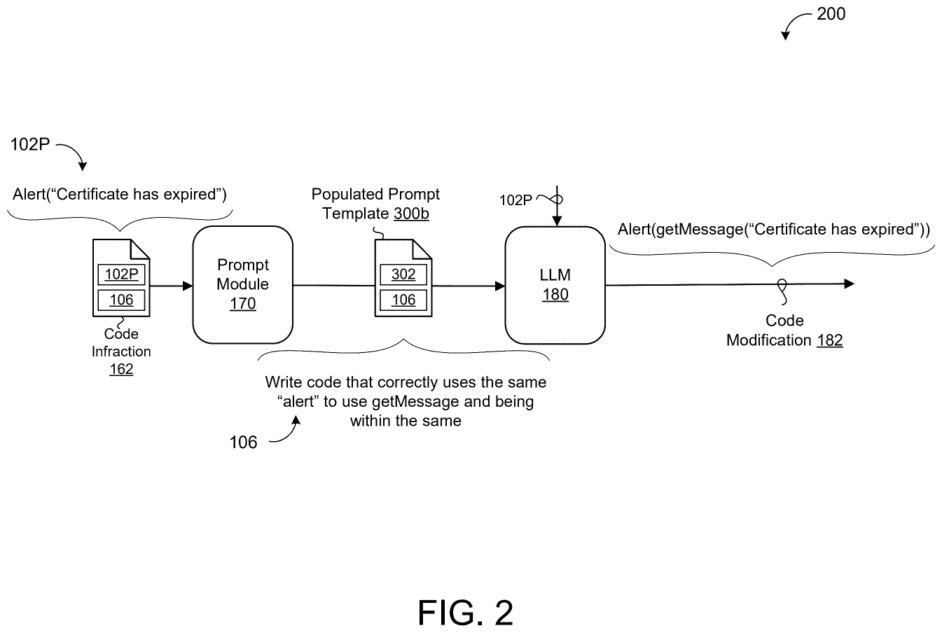

FIG. 2 illustrates an example code validator 200 that generates a code modification 182 for a code infraction 162. In the example shown, the prompt module 170 receives the code infraction 162 indicating a portion of the code file 102P associated with metadata 106. Here, the portion of the code file 102P includes corresponds to “Alert(”Certificate has expired“)” whereby the metadata 106 indicates that the portion of the code file 102P is associated with an “alert” result type. Notably, the portion of the code file 102P includes a plaintext message (e.g., “Certificate has expired”) in a first language that is not translatable to a second language because the plaintext message is hardcoded. The prompt module 170 selects the prompt template 300 and populates the selected prompt template 300 with the metadata 106 of the code file 102P to generate the populated prompt template 300b. The prompt module 170 may generate the populated prompt template 300b by replacing the metadata placeholder 304 with the metadata 106. In the example shown, the populated prompt template 300b corresponds to “Write code that correctly uses the same “alert” to use getMessage and being within the same” where “alert” is the metadata 106 and all other text is the request 302.

Continuing with the example, the LLM 180 processes the portion of the code file 102P and the populated prompt template 300b to generate the code modification 182 of “Alert(getMessage(“Certificate has expired”)).” In some examples, the LLM 180 generates the code modification 182 to include an application programming interface (API) call requesting translation of the plaintext message into one of a plurality of different languages. Thus, even though the plaintext message is in the first language, the API call may translate the plaintext message into a second language without causing any errors. In the example shown, the code modification 182 includes the API call of “getMessage” to allow the plaintext message to be translated into another language. Thus, in this example the modification module 190 modifies the portion of the code file 102P by inserting the API call into the portion of the code file 102P.

Referring back to FIG. 1, in some implementations, the code validator 200 generates a user presentation 196 of the code modification 182 before modifying the portion of the code file 102P with the code modification 182. The user presentation 196 may be visually presented to the user 10 via the user device 110 such that the user 10 may review the code modification 182 before implementing the code modification 182 as part of the code file 102. The user 10 may provide an affirmative response 112 to the user presentation 196 of the code modification 182 via the user device 110 indicating that the user 10 approves the code modification 182. Thus, the modification module 190 may modify the portion of the code file 102P based on receiving the affirmative response 112 to the user presentation 196. Alternatively, the user 10 may provide a negative response such that the modification module 190 does not modify the portion of the code file 102P with the code modification 182 and instead generates the notification 194. In yet other examples, the user 10 may provide a modified response that modifies the code modification 182. In these examples, the modification module 190 may modify the portion of the code file 102P based on the modified response (e.g., modified version of the code modification 182) instead of the code modification 182 generated by the LLM 180.

In some implementations, the portion of the code file 102P includes a plurality of parameters whereby only a subset of the parameters is associated with the code infraction 162. For instance, the portion of the code file 102P may correspond to “showFieldMsg(“ports”, “ports only apply to outbound rules for Bidirectional”, “info”).” Here, “ports” represents a first parameter, “ports only apply to outbound rules for Bidirectional” represents a second parameter, and “info” represents a third parameter. In this example, the second parameter may be the parameter associated with the code infraction 162 (e.g., parameter that causes the code infraction 162). More specifically, the second parameter is hardcoded text that is not translatable into another language. Accordingly, the modification module 190 may modify portion of the code file 102 by applying the code modification 182 to the one of the plurality of parameters associated with the code infraction 162 without altering the other parameters of the portion of the code file 102.

In some scenarios, translating plaintext messages in a first language to a second language involves reordering a sequencing of terms. For instance, the plaintext message of “Profile [current.name] already exists” in English may require the sequencing of terms to be recorded when translating the plaintext message into another language. That is, instead of having the [current.name] after the term “profile” in the other language, the [current.name] may need to be after the term “exists.” To that end, the LLM 180 may generate code modifications 182 that include abstracted plaintext messages translatable from the first language into the second language. For instance, the code modification 182 may replace the sequence of terms “Profile [current.name] already exists” with the modified sequence of terms “Profile {0} already exists, [current.name].” Notably, the modified sequence of terms parameterizes one or more of the terms such that the parametrized term is movable within the sequence of terms during translation. Thus, the abstracted plaintext message makes the sequence of terms translatable across various different languages despite the reordering of terms.

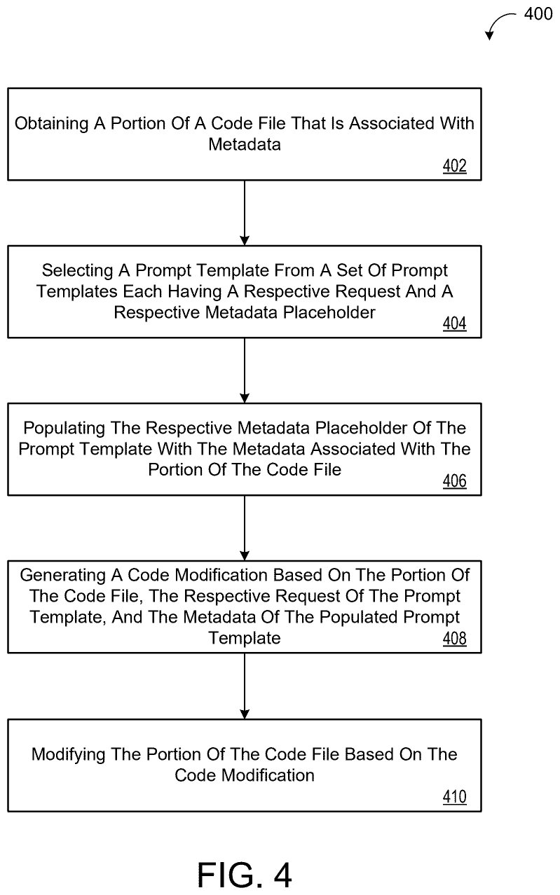

FIG. 4 is a flowchart of an exemplary arrangement of operations for a computer-implemented method 400 of using a code validator 200 to propose solutions for code infractions 162. At operation 402, the method 400 includes obtaining a portion of a code file 102P that is associated with metadata 106. For instance, the portion of the code file 102P may be indicated by a code infraction 162. At operation 404, the method 400 includes selecting a prompt template 300 from a set of prompt templates 300. The set of prompt templates 300 may include unpopulated prompts 300a. Each of the prompt templates includes a respective request 302 and a respective metadata placeholder 304. At operation 406, the method 400 includes populating the respective metadata placeholder 304 of the prompt template 300 with the metadata 106 associated with the portion of the code file 102P. Advantageously, by populating the respective metadata placeholder 304 with the metadata 106, the populated prompt template 300b now includes additional context regarding the portion of the code file 102P that is associated with the code infraction 162. At operation 408, the method 400 includes generating, using a model 180, a code modification 182 based on the portion of the code file 102P, the respective request 302 of the prompt template 300 and the metadata 106 of the populated prompt template 300b. Here, the populated prompt template 300b guides the LLM 180 in determining how to better generate the code modification 182 to correct the code infraction 162 of the portion of the code file 102P. At operation 410, the method 400 includes modifying the portion of the code file 102P based on the code modification 182.

As such, the method 400 leverages the natural language processing abilities of the LLM 180 to correct the code infractions 162. Moreover, the method 400 may include determining whether each code modification 182 satisfies the threshold 192 before modifying the portion of the code file 102P. Thus, the method 400 may sequentially progress through different prompt templates 300 to generate the optimal code modification 182. For example, initially selected prompt templates 300 may include relatively specific requests 302 to modify the code while subsequently selected prompt templates 300 include relatively broader requests 302 to modify the code. As such, the method 400 first processes populated prompt templates 300b with specific requests 302 and advances (if needed) to processing populated prompt templates 300b with requests 302 that are increasingly broader. Thus, if the method 400 produces a code modification 182 that satisfies the threshold 192, the method 400 does not need to proceed with processing broader requests 302 thereby reducing the amount of time and computational resources required to generate the code modification 182.

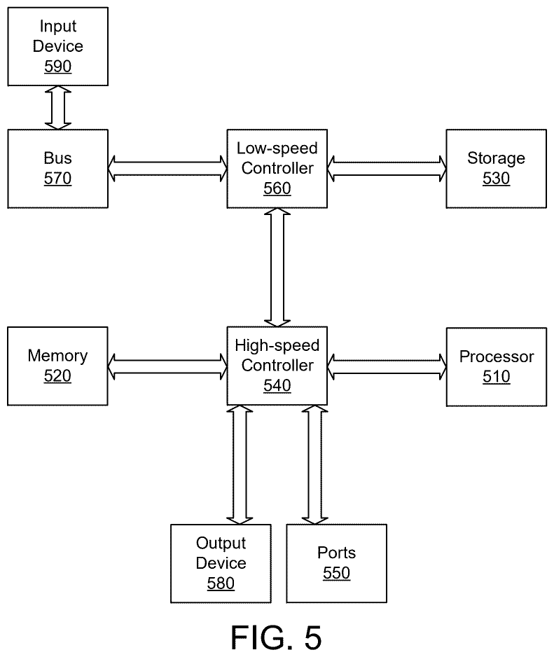

FIG. 5 is a schematic view of an example computing device 500 that may be used to implement the systems and methods described in this document. The computing device 500 is intended to represent various forms of digital computers, such as laptops, desktops, workstations, tablets, smartphones, servers, blade servers, mainframes, and other appropriate computers. The components shown here, their connections and relationships, and their functions, are meant to be illustrative only, and are not meant to limit implementations described and/or claimed in this document.

The computing device 500 includes a processor 510, memory 520, a storage device 530, a high-speed interface/controller 540 connecting to the memory 520 and high-speed expansion ports 550, and a low-speed interface/controller 560 connecting to a low-speed bus 570 and a storage device 530. Each of the components 510, 520, 530, 540, 550, and 560, are interconnected using various busses, and may be mounted on a common motherboard or in other manners as appropriate. The processor 510 can execute instructions for performing operations within the computing device 500, including instructions stored in the memory 520 or on the storage device 530 to display graphical information for a graphical user interface (GUI) on an external input/output device, such as display 580 coupled to high-speed interface 540. In other implementations, multiple processors and/or multiple buses may be used, as appropriate, along with multiple memories and types of memory. Also, multiple computing devices 500 may be connected, with each device providing portions of the necessary operations (e.g., as a server cluster, a group of blade servers, or a multi-processor system).

The memory 520 stores information within the computing device 500. The memory 520 may be a non-transitory computer-readable medium, a volatile memory unit(s), or non-volatile memory unit(s). The non-transitory memory 520 may be physical devices used to store programs (e.g., sequences of instructions) or data (e.g., program state information) on a temporary or permanent basis for use by the computing device 500. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random-access memory (DRAM), static random-access memory (SRAM), phase change memory (PCM) as well as disks or tapes.

The storage device 530 is capable of providing mass storage for the computing device 500. In some implementations, the storage device 530 is a non-transitory computer-readable medium. In various different implementations, the storage device 530 may be a floppy disk device, a hard disk device, an optical disk device, or a tape device, a flash memory or other similar solid state memory device, or an array of devices, including devices in a storage area network or other configurations. In additional implementations, a computer program product is embodied in a non-transitory information carrier. The computer program product contains instructions that, when executed, perform one or more methods, such as those described above. The information carrier is a non-transitory computer-readable medium, such as the memory 520, the storage device 530, or memory on processor 510.

The high-speed controller 540 manages bandwidth-intensive operations for the computing device 500, while the low-speed controller 560 manages lower bandwidth-intensive operations. Such allocation of duties is exemplary only. In some implementations, the high-speed controller 540 is coupled to the memory 520, the display 580 (e.g., through a graphics processor or accelerator), and to the high-speed expansion ports 550, which may accept various expansion cards (not shown). In some implementations, the low-speed controller 560 is coupled to the storage device 530 and a low-speed expansion port or input device 590. The low-speed expansion port 590, which may include various communication ports (e.g., USB, Bluetooth, Ethernet, wireless Ethernet), may be coupled to one or more input/output devices, such as a keyboard, a pointing device, a microphone, a touch screen, a scanner, or a networking device such as a switch or router, e.g., through a network adapter.

The computing device 500 may be implemented in a number of different forms, as shown in the figure. For example, it may be implemented as a standard server 500a or multiple times in a group of such servers 500a, as a laptop computer 500b, or as part of a rack server system 500c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor and can be implemented in a high-level procedural and/or object-oriented programming language, and/or in assembly/machine language. As used herein, the term “non-transitory computer-readable medium” refers to any computer program product, apparatus and/or device (e.g., magnetic discs, optical disks, memory, Programmable Logic Devices (PLDs)) used to provide machine instructions and/or data to a programmable processor, including a non-transitory computer-readable medium that receives machine instructions as a non-transitory computer-readable signal. The term “non-transitory computer-readable signal” refers to any signal used to provide machine instructions and/or data to a programmable processor.

A software application (i.e., a software resource) may refer to computer software that instructs a computing device to perform a specific function or set of functions. A software application may be executed by a processor, a virtual machine, a web browser, or another software component on the computing device. In some examples, a software application may be referred to as an “application,” an “app,” a “program,” or a “service.” Example applications include, but are not limited to, system diagnostic applications, system management applications, system maintenance applications, word processing applications, spreadsheet applications, messaging applications, media streaming applications, social networking applications, gaming applications, e-commerce applications, cloud computing applications, artificial intelligence applications, and blockchain applications.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a non-volatile memory or a volatile memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Non-transitory computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more implementations of the disclosure can be implemented on a computer having a display device, e.g., a LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method comprising:
obtaining a portion of a code file that is associated with metadata;
selecting a prompt template from a set of prompt templates, wherein each of the prompt templates includes a respective request and a respective metadata placeholder;
populating the respective metadata placeholder of the prompt template with the metadata associated with the portion of the code file;
generating, using a model, a code modification based on the portion of the code file, the respective request of the prompt template, and the metadata of the populated prompt template; and
modifying the portion of the code file based on the code modification.

2. The method of claim 1, further comprising:
obtaining a portion of a second code file comprising a second code infraction, the portion of the second code file associated with second metadata;
selecting, from the set of prompt templates, a second prompt template; and
populating the respective metadata placeholder of the second prompt template with the second metadata associated with the portion of the second code file.

3. The method of claim 2, further comprising:
generating, using the model, a second code modification based on the respective request of the second prompt template and the second metadata of the populated second prompt template;
determining that the second code modification fails to satisfy a threshold;
based on determining that the second code modification fails to satisfy the threshold, selecting, from the set of prompt templates, a third prompt template different from the second prompt template; and
populating the respective metadata placeholder of the third prompt template with the second metadata associated with the portion of the second code file.

4. The method of claim 3, further comprising:
generating, using the model, a third code modification based on the respective request and the second metadata of the populated third prompt template; and
modifying the portion of the second code file based on the third code modification.

5. The method of claim 4, further comprising determining that the third code modification satisfies the threshold, wherein modifying the portion of the second code file is further based on determining that the third code modification satisfies the threshold.

6. The method of claim 5, wherein:
determining that the second code modification fails to satisfy the threshold comprises determining that the second code modification fails to correct a code infraction; and
determining that the third code modification satisfies the threshold comprises determining that the third code modification corrects the code infraction.

7. The method of claim 1, wherein the portion of the code file comprises a code infraction and a plaintext message in a first language, the code infraction indicating that the plaintext message in the first language is not translatable to a second language different from the first language.

8. The method of claim 7, wherein:
the code modification comprises an application programming interface (API) call requesting translation of the plaintext message into one of a plurality of different languages; and
modifying the portion of the code file comprises inserting the API call into the portion of the code file.

9. The method of claim 7, wherein:
the code modification comprises an abstracted plaintext message translatable from the first language into the second language; and
modifying the portion of the code file comprises replacing the plaintext message with the abstracted plaintext message.

10. The method of claim 1, further comprising extracting the metadata associated with the portion of the code file, the metadata comprising a result type of the portion of the code file.

11. The method of claim 1, further comprising:
obtaining a plurality of training samples, each training sample comprising a training code infraction paired with a ground-truth code modification; and
training the model on the plurality of training samples.

12. The method of claim 11, wherein training the model on the plurality of training samples comprises updating parameters of the model.

13. The method of claim 1, further comprising:
before modifying the portion of the code file, generating a user presentation comprising the code modification; and
receiving an affirmative response to the user presentation,
wherein modifying the portion of the code file is further based on receiving the affirmative response to the user presentation.

14. The method of claim 1, wherein:
the portion of the code file comprises a plurality of parameters;
one of the plurality of parameters is associated with a code infraction; and
modifying the portion of the code file comprises applying the code modification to the one of the plurality of parameters.

15. The method of claim 1, wherein the model corresponds to a large language model (LLM).

16. The method of claim 1, wherein selecting the prompt template is based on an order of the set of prompt templates.

17. The method of claim 1, further comprising:
generating a prompt based on the respective request of the prompt template and the metadata of the populated prompt template,
wherein generating the code modification is further based on the prompt.

18. The method of claim 1, further comprising:
determining that the portion of the code file comprises plaintext in a first language that is not translatable to a second language; and
based on determining that the portion of the code file comprises plaintext in the first language that is not translatable to the second language, determining that the portion of the code file comprises a code infraction.

19. A system comprising:
data processing hardware; and
memory hardware in communication with the data processing hardware, the memory hardware storing instructions that when executed on the data processing hardware cause the data processing hardware to perform operations comprising:
obtaining a portion of a code file that is associated with metadata;
selecting a prompt template from a set of prompt templates, wherein each of the prompt templates includes a respective request and a respective metadata placeholder;
populating the respective metadata placeholder of the prompt template with the metadata associated with the portion of the code file;
generating, using a model, a code modification based on the respective request of the prompt template and the metadata of the populated prompt template; and
modifying the portion of the code file based on the code modification.

20. A computer-readable medium having instructions that, when executed by data processing hardware, causes the data processing hardware to perform operations comprising:
obtaining a portion of a code file that is associated with metadata;
selecting a prompt template from a set of prompt templates, wherein each of the prompt templates includes a respective request and a respective metadata placeholder;
populating the respective metadata placeholder of the prompt template with the metadata associated with the portion of the code file;
generating, using a model, a code modification based on the respective request of the prompt template and the metadata of the populated prompt template; and
modifying the portion of the code file based on the code modification.
